(19) United States
(12) Patent Application Publication
(10) Pub. No.: US 2018/0348521 A1
(43) Pub. Date: Dec. 6, 2018

(54) HALF MIRROR, LIGHT GUIDE DEVICE, AND DISPLAY DEVICE

(71) Applicant: SEIKO EPSON CORPORATION, Tokyo (JP)

(72) Inventors: Hayato MATSUKI, Suwa-Shi (JP); Kunihiko YANO, Shiojiri-Shi (JP); Koichi TAKEMURA, Chino-Shi (JP); Shohei YOSHIDA, Shimosuwa-Machi (JP)

(73) Assignee: SEIKO EPSON CORPORATION, Tokyo (JP)

(21) Appl. No.: 15/990,082

(22) Filed: May 25, 2018

(30) Foreign Application Priority Data
May 31, 2017 (JP) 2017-107694

(51) Int. Cl. G02B 27/01; G02B 27/14; F21V 8/00

(52) U.S. Cl. CPC G02B 27/0172; G02B 2027/0118; G02B 6/0055; G02B 27/142

(57) ABSTRACT

A half mirror includes a silver layer and an anti-aggregation layer in contact with the silver layer. The anti-aggregation layer may be composed of ITO or IGO. Alternatively, the anti-aggregation layer may be composed of an organic molecular film having a thiol group. Alternatively, the anti-aggregation layer may be composed of an alloy including silver in an amount of 97% or more and an element X, in which the element X is any one of Au, Mg, Zn, Cu, Al, Si, Pd, Sn, Pt, Ti, and Cr.

### BACKGROUND

### 1. Technical Field

The present invention relates to a half mirror, a light guide device, and a display device.

### 2. Related Art

As a wearable information appliance, an image display device worn on a user's head, such as a head-mounted display, has been recently provided. Furthermore, a see-through image display device is known. The see-through image display device allows the user wearing it to see an image composed of display elements and to see through it at the same time. The image display device of this type includes a half mirror that reflects image light toward the user's eyes and allows external light to pass therethrough toward the user's eyes.

JP-A-2014-224891 discloses a half mirror including a silver layer, a first dielectric multilayer film including a first aluminum oxide layer and a titanium oxide layer, and a second dielectric multilayer including a zirconium oxide-based dielectric layer and a second aluminum oxide layer. JP-A-2014-224891 describes that the half mirror mainly includes silver as a metal, which causes less light loss due to absorption than aluminum, and thus the silver layer is allowed to have a larger thickness, enabling stable formation of the silver layer.

### SUMMARY

In the half mirror including a dielectric multilayer film, the reflectance for the p-polarized component at an angle near Brewster's angle is very close to 0%. Thus, if the incident angle of the light onto the half mirror is substantially the same as Brewster's angle due to the design of the display device, only the s-polarized component is used as image light, leading to low light use efficiency.

A half mirror including a metal film is employed to use both the p-polarized component and the s-polarized component such that the light use efficiency does not decrease. In the half mirror including the metal film, the reflectance and the transmittance is able to be adjusted by controlling the thickness of the metal film. For example, in JP-A-2014-224891, a silver film having a thickness of about 19 nm is employed to have a reflectance of about 35% over the entire visible wavelength range. A silver film having a further smaller thickness may be used to have a further lower reflectance. In such a case, it is difficult to produce a half mirror having desired optical properties.

An advantage of some aspects of the invention is that a half mirror having desired optical properties and a low reflectance, a light guide device including the above-described half mirror, and a display device including the above-described light guide device are provided.

A half mirror according to a first aspect of the invention includes a silver layer and an anti-aggregation layer in contact with the silver layer.

According to the first aspect of the invention, the anti-aggregation layer reduces aggregation of silver, and thus aggregation, which adversely affects the optical properties, is less likely to occur, enabling formation of a silver layer having a small thickness. Thus, a half mirror having desired optical properties and a low reflectance is obtained.

In the half mirror according to the first aspect, the anti-aggregation layer may be composed of one of indium tin oxide (ITO) and indium gallium oxide (IGO). Alternatively, the anti-aggregation layer may be composed of an organic molecular film having a thiol group. Alternatively, the anti-aggregation layer may be composed of an alloy including silver in an amount of 97% or more and an element X (X=any one of Au, Mg, Zn, Cu, Al, Si, Pd, Sn, Pt, Ti, and Cr).

The inventors have confirmed that the half mirror having preferable optical properties and a low reflectance is obtained by the anti-aggregation layer formed of the above-described material. This is described later in detail.

In the half mirror according to the first aspect, the silver layer may have a thickness of 12 nm or less.

With this configuration, a half mirror having a low reflectance of about 20%, for example, is obtained.

The half mirror according to the first aspect may further include a dielectric layer in contact with the silver layer and a dielectric layer in contact with the anti-aggregation layer.

With this configuration, spectral reflectance is able to be adjusted by the dielectric layer, and thus the reflectance is made low over a wide visible wavelength range.

A half mirror according to a second aspect of the invention includes an alloy layer including silver in an amount of 97% or more and an element X (X=any one of Au, Mg, Zn, Cu, Al, Si, Pd, Sn, Pt, Ti, and Cr).

According to the second aspect of the invention, instead of the layer including only silver, the alloy layer including silver and the element X is employed. This reduces aggregation of silver, enabling formation of a silver alloy layer having a small thickness. Thus, a half mirror having desired optical properties and a low reflectance is obtained.

In the half mirror according to the second aspect of the invention, the alloy layer may have a thickness of 12 nm or less.

With this configuration, a half mirror having a low reflectance of about 20%, for example, is obtained.

The half mirror according to the second aspect of the invention may further include a dielectric layer in contact with the alloy layer.

With this configuration, spectral reflectance is able to be adjusted by the dielectric layer, and thus the reflectance is made low over a wide visible wavelength range.

A light guide device according to a third aspect of the invention includes a light guide and the half mirror according to any one of the aspects that is configured to reflect some of light traveled in the light guide.

Since the light guide device according to the third aspect of the invention includes the half mirror according to one of the aspects of the invention, the light guide device has desired optical properties.

A display device according to a fourth aspect of the invention includes an image forming device and the light guide device according to the third aspect of the invention that is configured to guide image light generated by the image forming device.

Since the display device according to the fourth aspect of the invention includes the light guide device according to the third aspect of the invention, the display device has desired display characteristics.

### BRIEF DESCRIPTION OF THE DRAWINGS

The invention will be described with reference to the accompanying drawings, wherein like numbers reference like elements.

FIG. 1 is a cross-sectional view of a half mirror according to a first embodiment of the invention.

FIG. 2 is a view for explaining the operation of the half mirror.

FIG. 3 is a view for explaining a problem of a conventional half mirror including a dielectric multilayer film.

FIG. 4 is an SEM photograph showing a surface of a silver layer included in a half mirror of Example 1.

FIG. 5 is an SEM photograph showing a surface of a silver layer included in a half mirror of Example 2.

FIG. 6 is an SEM photograph showing a surface of a silver layer included in a half mirror of Comparative Example 1.

FIG. 7 is an SEM photograph showing silver aggregation in Comparative Example 1.

FIG. 8 is a cross-sectional view of a half mirror used in evaluation of optical properties.

FIG. 9 is a diagram indicating spectral reflectance and spectral transmittance of the half mirror of Example 1.

FIG. 10 is a diagram indicating spectral reflectance and spectral transmittance of the half mirror of Example 2.

FIG. 11 is a diagram indicating spectral reflectance and spectral transmittance of the half mirror of Comparative Example 1.

FIG. 12 is a cross-sectional view of a half mirror according to a second embodiment of the invention.

FIG. 13 is an SEM photograph showing appearance of a half mirror of Example 3.

FIG. 14 is an SEM photograph showing appearance of a half mirror of Example 4.

FIG. 15 is an SEM photograph showing appearance of a half mirror of Comparative Example 2.

FIG. 16 is a diagram indicating spectral reflectance and spectral transmittance of the half mirror of Example 3.

FIG. 17 is a diagram indicating spectral reflectance and spectral transmittance of the half mirror of Example 4.

FIG. 18 is a cross-sectional view of a display device according to a third embodiment of the invention.

FIG. 19 is a rear view of a light guide device viewed from a user.

FIG. 20 is a view indicating light paths of image light in the light guide device.

FIG. 21 is a magnified view of an optical element.

FIG. 22 is a plan view of a display device according to a fourth embodiment of the invention.

### DESCRIPTION OF EXEMPLARY EMBODIMENTS

### First Embodiment: Half Mirror

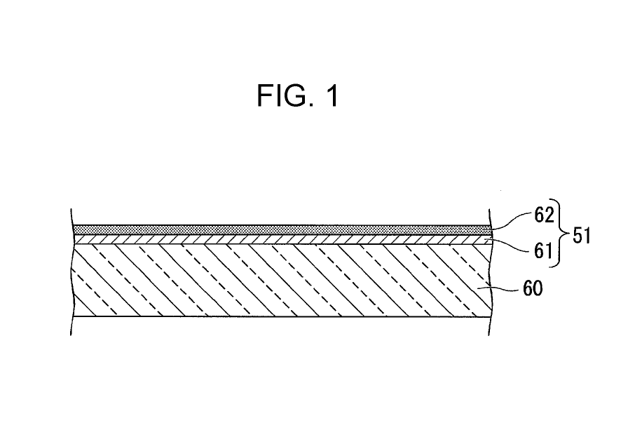

Hereinafter, a first embodiment of the invention is described with reference to FIG. 1 to FIG. 11. A half mirror according to this embodiment is preferably employed in a display device described below as a half mirror for extracting image light. FIG. 1 is a cross-sectional view of a half mirror according to the first embodiment. In the drawings, for ease of understanding of the components, the components are illustrated at different scales in some cases.

As illustrated in FIG. 1, a half mirror 51 according to the embodiment is disposed on a surface of a base 60. The half mirror 51 includes a silver layer 62 and an anti-aggregation layer 61 in contact with the silver layer 62. The silver layer 62 is disposed over the base 60. The anti-aggregation layer 61, which is a foundation layer of the silver layer 62, is disposed between the silver layer 62 and the base 60.

The base 60 is composed of a material having light transmissivity, such as glass and plastic. The thickness of the base 60 is about 0.5 mm to about 2 mm, for example, but the base 60 may have any thickness.

The anti-aggregation layer 61 functions as a foundation layer and prevents silver aggregation caused when the silver layer having a small thickness is formed on the base 60. The anti-aggregation layer 61 may be formed of indium tin oxide (ITO) or indium gallium oxide (IGO), for example.

Alternatively, the anti-aggregation layer 61 may be formed of an organic molecular film having a thiol group. Specific examples of the material of the organic molecular film having a thiol group include 3-Mercaptopropylmethyldimethoxysilane and (3-Mercaptopropyl) trimethoxysilane.

Alternatively, the anti-aggregation layer 61 may be composed of an alloy including silver (Ag) in an amount of 97% or more and an element X (X=any one of Au, Mg, Zn, Cu, Al, Si, Pd, Sn, Pt, Ti, and Cr) in an amount of less than 3%.

The thickness of the anti-aggregation layer 61 is about 0.1 to about 2 nm, for example, but the anti-aggregation layer 61 may have any thickness.

The silver layer 62 of this embodiment is composed only of silver. The silver layer 62 has a thickness of 12 nm or less and is formed over the entire surface of the anti-aggregation layer 61. The half mirror 51 including the silver layer 62 has a relatively low reflectance of about 5% to about 30%, for example.

Problems involved in a conventional half mirror including a dielectric multilayer film are described with reference to FIG. 3. FIG. 3 illustrates an optical element for extracting light in a light guide device. As illustrated in FIG. 3, an optical element 110 includes a base 60 as a light guide and a plurality of half mirrors 101. The light L includes a s-polarized component Ls and a p-polarized component Lp. The content of the respective polarized components Ls and Lp is 50%. The light L obliquely enters the half mirror 101 at a predetermined incident angle α. The reflectance of the half mirror 101 is 23%, for example.

If the incident angle α of the light L is equal to Brewster's angle, the reflectance for the p-polarized component Lp is substantially 0%. Thus, the p-polarized component Lp passes through the half mirror 101 as it is and travels inside the base 60 without being extracted to the outside. In this case, the reflectance for the s-polarized component Ls is set at 46% such that the reflectance of the half mirror 101 for the entire polarized components of the light L becomes 23%.

The output light from the first half mirror 101 that receives the light L first is referred to as output light L3. The output light from the second half mirror 101 that receives the light L after the first half mirror 101 is referred to as output light L4. The percentage of the light quantity of the output light L3 (the s-polarized component Ls) with respect to the total light quantity is 23% (=0.5×0.46), and the percentage of the light quantity of the output light L4 (the s-polarized component Ls) with respect to the total light quantity is 12.42% (=0.5×0.54×0.46). Thus, the difference in brightness between the output light from the first half mirror 101 and the output light from the second half mirror 101 is 10.58%.

As seen from the above, in the conventional half mirror 101, the difference in brightness between the output light rays from the two half mirrors located next to each other is substantially equal to the brightness between the output light rays from the second half mirror. Thus, unevenness in brightness of the output light is large.

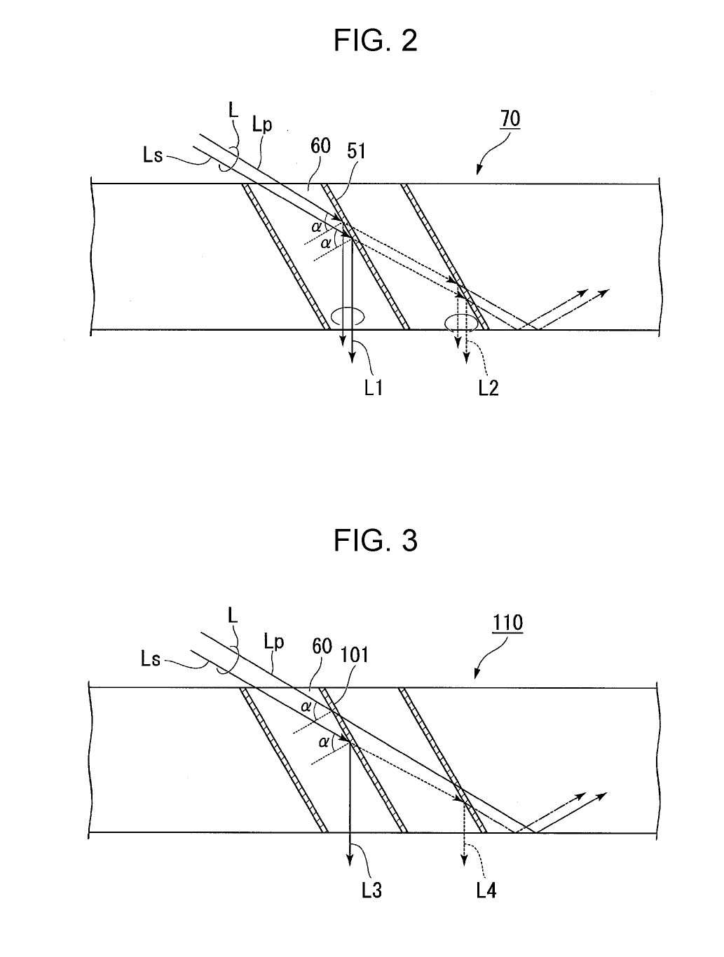

Next, operation of the half mirror 51 of this embodiment is described with reference to FIG. 2. FIG. 2 illustrates an optical element for extracting light used in a light guide device, which is configured to guide image light, in the same way as in FIG. 3. As illustrated in FIG. 2, an optical element 70 includes a base 60 as a light guide and a plurality of half mirrors 51. Light L includes a s-polarized component Ls and a p-polarized component Lp. The content of the respective polarized components Ls and Lp is 50%. The light L obliquely enters the half mirror 51 at a predetermined incident angle α. The reflectance of the half mirror 51 is 23%, for example.

In the half mirror including a metal layer such as a silver layer, the reflectance for the p-polarized component Lp does not become 0% even if the incident angle α is equal to Brewster's angle, contrary to the half mirror including only the dielectric multilayer film. The reflectance for the s-polarized component Ls and that of the p-polarized component Lp are both able to be set at 23%. Thus, the p-polarized component Lp is extracted to the outside together with the s-polarized component Ls.

The output light from the first half mirror 51 that receives the light L first is referred to as output light L1. The output light from the second half mirror 51 that receives the light L after the first half mirror 51 is referred to as output light L2. The percentage of the light quantity of the output light L1 (the s-polarized component Ls+the p-polarized component Lp) with respect to the total light quantity is 23% (=0.5×0.23+0.5×0.23), and the percentage of the light quantity of the output light L2 (the s-polarized component Ls+the p-polarized component Lp) with respect to the total light quantity is 17.71% (=0.5×0.77×0.23+0.5×0.77×0.23). Thus, the difference in brightness between the output light from the first half mirror 51 and the output light from the second half mirror 51 is 5.29%.

As seen from the above, if the half mirror 51 of the embodiment has the reflectance equal to that of the conventional half mirror 101, the difference in brightness between the output light rays from the half mirrors 51 located next to each other is reduced to a half of that from the conventional half mirrors 51. Thus, unevenness in brightness of the output light rays from the half mirrors of the embodiment is smaller than that of the output light from the conventional half mirrors.

The half mirror including a metal layer may have a reflectance of 35%. In such a case, the difference in brightness between the output light rays from the half mirrors located next to each other is 12.25% when calculated as above. The brightness unevenness is large. To reduce the brightness unevenness, the reflectance of the half mirror is set at 30% or less. This reduces the difference in brightness between the output light rays from the half mirrors located next to each other to about 10% or less. In view of this, the reflectance of the half mirror is preferably 30% or less. It has been confirmed by an experiment that the brightness difference of 10% or less is unlikely to be recognized by a human eye and the unevenness is invisible. Furthermore, it has been confirmed by an experiment that when the brightness difference is 5% or less, the unevenness is completely invisible.

The inventors of this invention produced various types of half mirrors having the configurations of the embodiment and evaluated appearance and optical properties of the silver layers of the half mirrors. The results of the evaluations are described below.

A half mirror including an anti-aggregation layer formed of IGO and a silver layer on the anti-aggregation layer was produced as Example 1. A half mirror including an anti-aggregation layer formed of 3-Mercaptopropylmethyldimethoxysilane or (3-Mercaptopropyl)trimethoxysilane, which is an organic thin film, and a silver layer on the anti-aggregation layer was produced as Example 2. A half mirror including a silver layer directly on a base and not including an anti-aggregation layer was produced as Comparative Example 1. The target value of the thickness of the silver layer was 10 nm in the half mirrors of the Example 1, Example 2, and Comparative Example 1. As the base, BK7, which is one type of optical glass, was used.

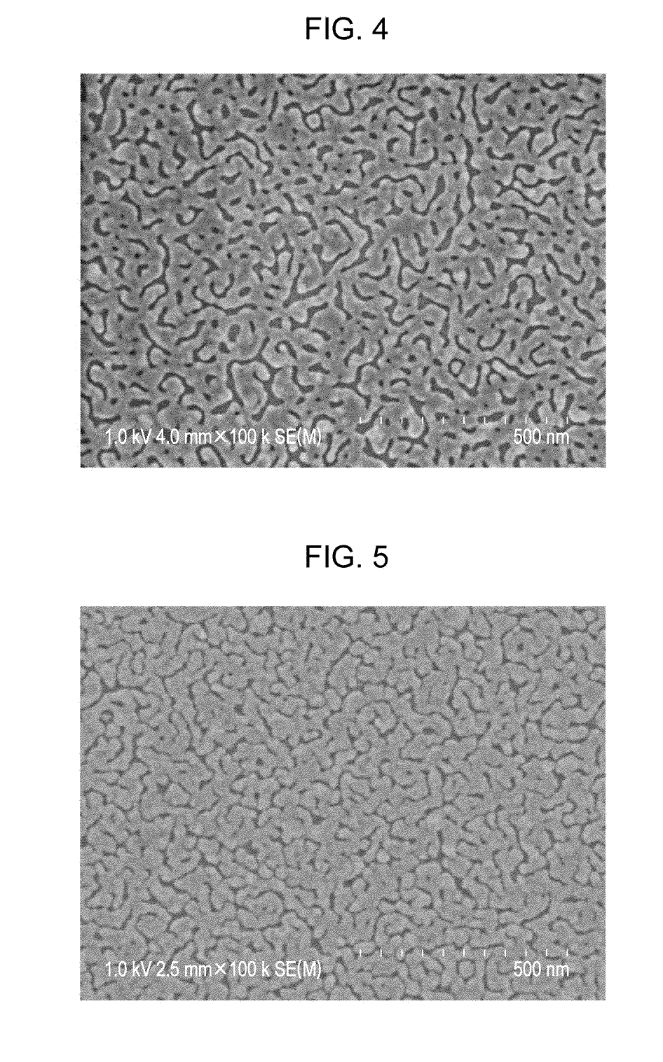

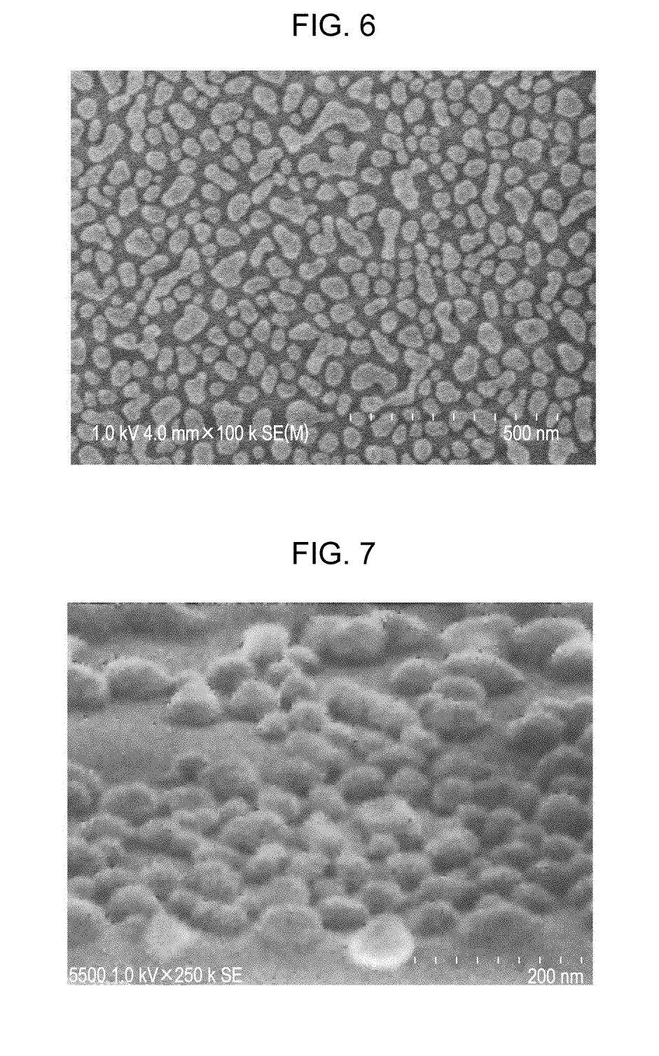

FIG. 4 is an SEM photograph showing the surface of the silver layer included in the half mirror of Example 1. FIG. 5 is an SEM photograph showing the surface of the silver layer included in the half mirror of Example 2. FIG. 6 is an SEM photograph showing the surface of the silver layer included in the half mirror of Comparative Example 1. FIG. 7 is an SEM photograph particularly showing aggregation of silver in Comparative Example 1. In the SEM photographs, relatively bright portions indicate that silver is present and relatively dark portions indicate that a foundation is exposed. The accelerating voltage of the SEM was 1 kV, and the magnification of the SEM was 100,000.

As indicated in FIG. 6 and FIG. 7, the half mirror of Comparative Example 1 not including an anti-aggregation layer has many aggregations of silver over the entire surface of the base. The diameter of the aggregation was about 40 nm. The aggregations were isolated from each other on the base and no continuous film was formed. If light enters the base having the aggregations of silver thereon, plasmon absorption causes the light loss.

Compared with this, as indicated in FIG. 4, in the half mirror of Example 1 including the anti-aggregation layer formed of IGO, aggregations of silver were connected to each other to form a dense film in the form of a silver layer, although the aggregation of silver were isolated from each other in the half mirror of Comparative Example 1. Furthermore, as indicated in FIG. 5, the appearance of the half mirror of Example 2 including the anti-aggregation layer formed of an organic thin film was similar to that of the half mirror of Example 1. It was confirmed that the anti-aggregation layer used as the foundation layer of the silver layer reduces aggregation of silver.

Since the silver layer of the invention has a very small thickness, the silver layer may have portions through which the foundation is exposed as indicated in FIG. 4 and FIG. 5. Furthermore, in the silver layer, the aggregations of silver are not completely isolated from each other and are connected to each other at at least a portion thereof.

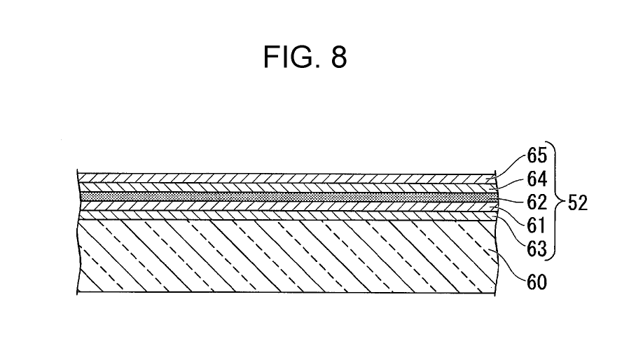

Next, a half mirror illustrated in FIG. 8 was produced for evaluation of optical properties of the half mirror. As illustrated in FIG. 8, a half mirror 52 for evaluation of optical properties includes a base 60, a first dielectric layer 63, an anti-aggregation layer 61, a silver layer 62, a second dielectric layer 64, and a third dielectric layer 65. The first dielectric layer 63, the anti-aggregation layer 61, the silver layer 62, and the second dielectric layer 64 are laminated on the surface of the base 60 in this order. Evaluation of the half mirror 52 of this type carried out in the atmosphere shows optical properties of the half mirror 52 including a simple dielectric multilayer film. As described above, the half mirror 52 further includes the dielectric layer in contact with the silver layer 62 and the dielectric layer in contact with the anti-aggregation layer 61.

As Example 1, a half mirror including ZrO₂ in the form of the first dielectric layer, the anti-aggregation layer formed of IGO, the silver layer, ZrO₂ in the form of the second dielectric layer, and SiO₂ in the form of the third dielectric layer in this order on the base was produced. As Example 2, a half mirror including ZrO₂ in the form of the first dielectric layer, the anti-aggregation layer formed of 3-Mercaptopropylmethyldimethoxysilane or (3-Mercaptopropyl)trimethoxysilane as an organic thin film, the silver layer, ZrO₂ in the form of the second dielectric layer, and SiO₂ in the form of the third dielectric layer in this order on the base was produced. As Comparative Example 1, a half mirror including ZrO₂ in the form of the first dielectric layer, the silver layer, ZrO₂ in the form of the second dielectric layer, and SiO₂ in the form of the third dielectric layer in this order on the base was produced.

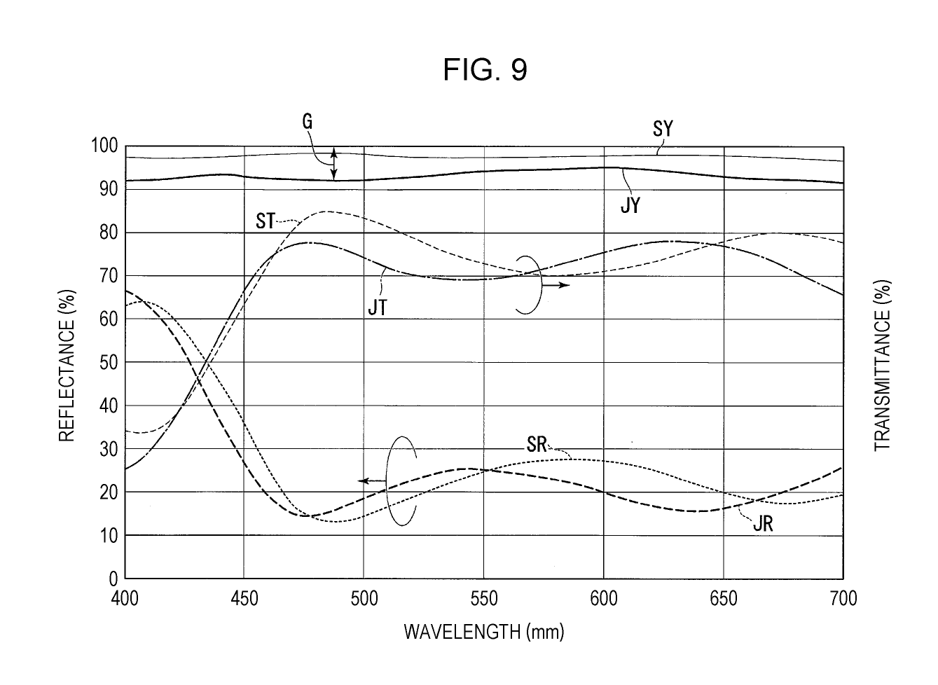

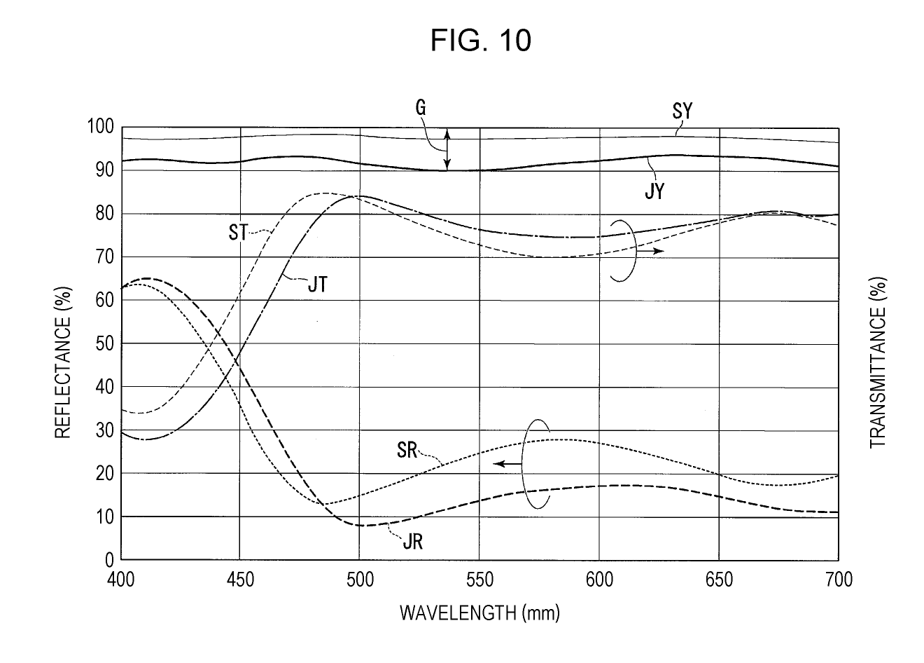

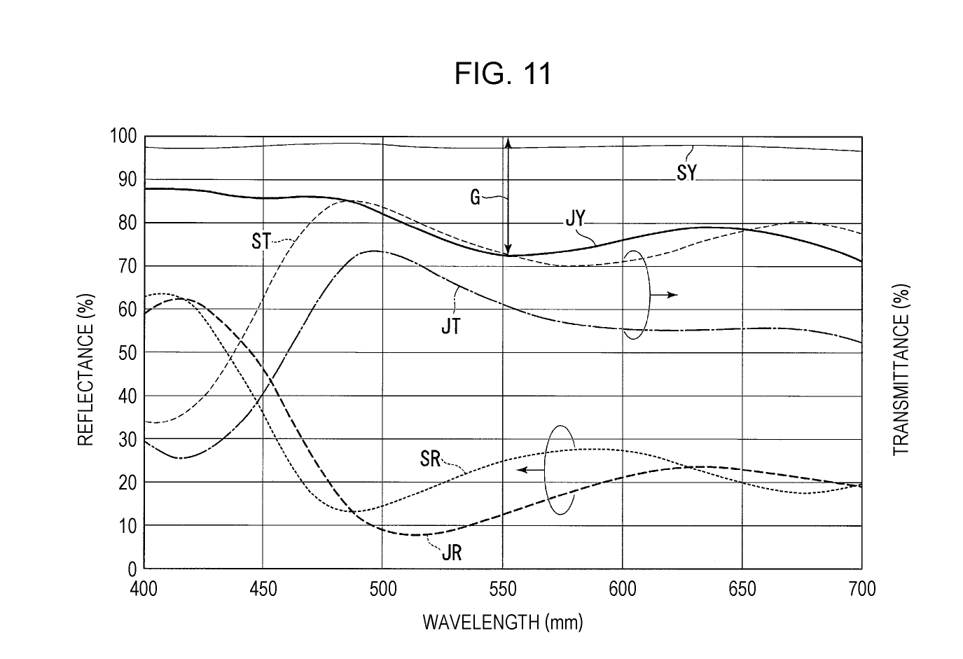

FIG. 9 is a diagram indicating spectral reflectance and spectral transmittance of the half mirror of Example 1. FIG. 10 is a diagram indicating spectral reflectance and spectral transmittance of the half mirror of Example 2. FIG. 11 is a diagram indicating spectral reflectance and spectral transmittance of the half mirror of Comparative Example 1.

In FIG. 9 to FIG. 11, a horizontal axis indicates a wavelength (nm) and a vertical axis indicates reflectance (%) or transmittance (%) or the sum (%) of the reflectance and the transmittance. A curve with a reference symbol SR indicates designed values (simulated values) of spectral reflectance. A curve with a reference symbol ST indicates designed values (simulated values) of spectral transmittance. A curve with a reference symbol SY indicates the sums of the designed values (simulated values) of reflectance and the designed values (simulated values) of transmittance. A curve with a reference symbol JR indicates actual measured values of spectral reflectance. A curve with a reference symbol JT indicates actual measured value of spectral transmittance. A curve with a reference symbol JY indicates the sums of the actual measured values of reflectance and the actual measured values of transmittance.

A difference G between the sum of the reflectance and the transmittance and 100% probably corresponds to the amount of light absorbed by the half mirror. Then, the spectral curve JY indicating the sum of the actual measured values is focused. As indicated in FIG. 11, in the half mirror of Comparative Example 1, the difference G is relatively large. It was confirmed that the light is absorbed. The light absorption is probably caused by plasmon absorption due to silver aggregation.

Compared with this, in the half mirror of Example 1, as indicated in FIG. 9, the difference G is smaller than that in Comparative Example 1. It was confirmed that the light absorption is reduced a lot. Furthermore, as indicated in FIG. 10, in the half mirror of Example 2, the difference G is smaller than that in Comparative Example 1, as in Example 1. It was confirmed that the light absorption is reduced a lot.

In the half mirror 51 of the embodiment, the use of the silver layer 62, instead of the dielectric multilayer film, enables the p-polarized component to be used when an incident angle is close to Brewster's angle. Thus, of the half mirrors having the same light use efficiency, the half mirror including the silver layer 62, which enables both the s-polarized component and the p-polarizes component to be used, has higher reflectance and allows the reflected light therefrom to have higher brightness than the half mirror including the dielectric multilayer film, which reflects only the s-polarized component.

The reduction of aggregation of silver by using the anti-aggregation layer 61 as the foundation of the silver layer 62 enables the silver layer having a small thickness to be relatively stably formed. This reduces the light absorption at the half mirror 51, and thus a half mirror having desired optical properties and a low reflectance is obtained. In particular, the silver layer 62 having a thickness of 12 nm or less reduces the reflectance of the half mirror to about 30% or less.

### Second Embodiment

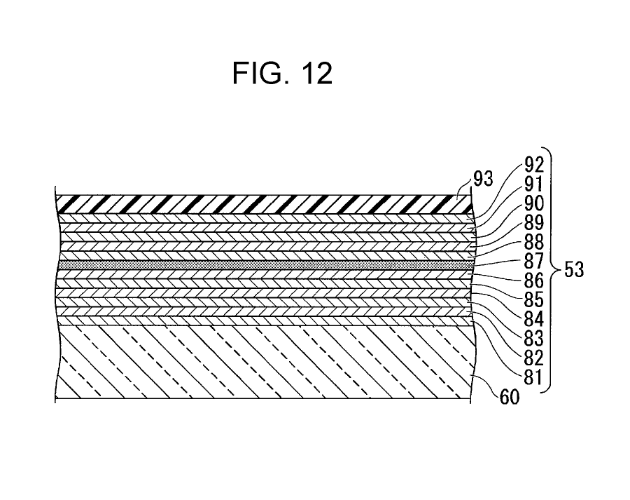

Hereinafter, a second embodiment of the invention is described with reference to FIG. 12 to FIG. 20. A half mirror of the second embodiment has the same basic configuration as that of the first embodiment except for the configuration of the dielectric layers. FIG. 12 is a cross-sectional view of a half mirror of the second embodiment. In FIG. 12, components identical to those in the figures of the first embodiment are assigned the same reference numerals as those in the first embodiment and are not described.

As illustrated in FIG. 12, a half mirror 53 of this embodiment includes a first dielectric layer 81, a second dielectric layer 82, a third dielectric layer 83, a fourth dielectric layer 84, a fifth dielectric layer 85, a sixth dielectric layer 86, a silver layer 87, a seventh dielectric layer 88, an eighth dielectric layer 89, a ninth dielectric layer 90, a tenth dielectric layer 91, an eleventh dielectric layer 92, and an adhesive layer 93. The half mirror 53 of this embodiment does not include the anti-aggregation layer 61 that is included in the first embodiment.

The silver layer 87 of this embodiment includes silver in an amount of 97% or more and an element X (X=any one of Au, Mg, Zn, Cu, Al, Si, Pd, Sn, Pt, Ti, and Cr) in an amount of less than 3%. The thickness of the alloy layer is 12 nm or less. The element X may include only one of Au, Mg, Zn, Cu, Al, Si, Pd, Sn, Pt, Ti, and Cr or two or more of them. When the element X includes two or more of the elements, the sum of the contents of the two or more elements is less than 3%. In other words, the half mirror 53 of this embodiment further includes the dielectric layers in contact with the alloy layer constituting the silver layer 87.

The inventors have conducted various studies and found that if the alloy layer includes silver in an amount of less than 97%, the aggregation of silver is reduced, but the light absorption by the element X is increased, and thus light loss is caused in the light passing therethrough. The light loss was particularly observed in the visible wavelength range. In view of this, the silver content needs to be 97% or more. Furthermore, the content of the element X in the alloy layer is preferably 0.5% or more and less than 3%. If the content of the element X is less than 0.5%, the aggregation of silver is not sufficiently reduced.

The first dielectric layer 81, the second dielectric layer 82, the third dielectric layer 83, the fourth dielectric layer 84, the fifth dielectric layer 85, the sixth dielectric layer 86, the seventh dielectric layer 88, the eighth dielectric layer 89, the ninth dielectric layer 90, the tenth dielectric layer 91, and the eleventh dielectric layer 92 may be formed of any combination of materials widely used as materials of a dielectric multilayer film, such as Al₂O₃, ZrO₂, SiO₂, and TiO₂. In this example, eleven dielectric layers are employed, but the number of dielectric layers may be suitably changed in accordance with optical properties required for the half mirror 53. Furthermore, the thickness of each dielectric layer may be suitably changed in accordance with optical properties required for the half mirror 53.

The adhesive layer 93 is composed of an adhesive and is used when the bases 60 each having the half mirror 53 on one surface thereof are bonded together to produce an optical element, which is described in an embodiment described later. Examples of the adhesive layer 93 include an ultraviolet curable adhesive having light transmissivity, such as an acrylic adhesive and an epoxy adhesive.

The half mirror 53 of this embodiment does not include the anti-aggregation layer 61. However, the silver layer 87 composed of the alloy including silver and the element X reduces aggregation of silver. In other words, aggregation of silver is reduced by the silver layer 87 including the element X.

The inventors produced various half mirrors according to the embodiment and evaluated appearance and optical properties of the half mirrors. The results are described below.

A half mirror having layers as indicated in Table 1 below was produced as Example 3. The target value of the reflectance of the half mirror is 15%. In the silver layer, the silver (Ag) content is 99% and the copper (Cu) content is 1%. The copper may be a copper alloy. In such a case, the gold (Au) content is 0.5% and the copper (Cu) content is 0.5%. The numbers suffixed to the layers in Table 1 correspond to the reference numerals of the layers in FIG. 12.

TABLE 1

| | | Physical | Refractive |
|---|---|---|---|
| | | Thickness | Index |
| No. | Material | (nm) | (550 nm) |
| Dielectric Layer 81 | Al₂O₃ | 106.7 | 1.57 |
| Dielectric Layer 82 | ZrO₂ | 25.1 | 1.97 |
| Dielectric Layer 83 | SiO₂ | 17.5 | 1.46 |
| Dielectric Layer 84 | Al₂O₃ | 52.0 | 1.57 |
| Dielectric Layer 85 | TiO₂ | 31.6 | 2.40 |
| Dielectric Layer 86 | Al₂O₃ | 8.8 | 1.57 |
| Silver Layer 87 | Ag + Cu Alloy | 10.2 | 0.055-3.3i |
| Dielectric Layer 88 | ZrO₂ | 94.8 | 1.97 |
| Dielectric Layer 89 | Al₂O₃ | 150.8 | 1.57 |
| Dielectric Layer 90 | SiO₂ | 67.9 | 1.46 |
| Dielectric Layer 91 | Al₂O₃ | 61.0 | 1.57 |
| Dielectric Layer 92 | SiO₂ | 120.4 | 1.46 |
| Adhesive Layer 93 | — | 390.2 | 1.48 |
| Base | BK7 | — | 1.52 |

A half mirror having layers as indicated in Table 2 below was produced as Example 4. The target value of the reflectance of the half mirror is 20%. In the silver layer, the silver (Ag) content is 99% and the copper (Cu) content is 1%. The copper may be a copper alloy. In such a case, the gold (Au) content is 0.5% and the copper (Cu) content is 0.5%. The numbers suffixed to the layers in Table 2 correspond to the reference numerals of the layers in FIG. 12.

TABLE 2

| | | Physical | Refractive |
|---|---|---|---|
| | | Thickness | Index |
| No. | Material | (nm) | (550 nm) |
| Dielectric Layer 81 | Al₂O₃ | 95.0 | 1.57 |
| Dielectric Layer 82 | ZrO₂ | 28.7 | 1.97 |
| Dielectric Layer 83 | SiO₂ | 33.3 | 1.46 |
| Dielectric Layer 84 | Al₂O₃ | 31.5 | 1.57 |
| Dielectric Layer 85 | TiO₂ | 33.8 | 2.40 |
| Dielectric Layer 86 | Al₂O₃ | 8.8 | 1.57 |
| Silver Layer 87 | Ag + Cu Alloy | 11.9 | 0.055-3.3i |
| Dielectric Layer 88 | ZrO₂ | 95.2 | 1.97 |
| Dielectric Layer 89 | Al₂O₃ | 146.1 | 1.57 |
| Dielectric Layer 90 | SiO₂ | 64.4 | 1.46 |
| Dielectric Layer 91 | Al₂O₃ | 64.7 | 1.57 |
| Dielectric Layer 92 | SiO₂ | 122.0 | 1.46 |
| Adhesive Layer 93 | — | 390.2 | 1.48 |
| Base | BK7 | — | 1.52 |

A half mirror including a silver layer composed only of silver, instead of the alloy layer including silver and copper in Examples 3 and 4, on a base was produced as Comparative Example 2.

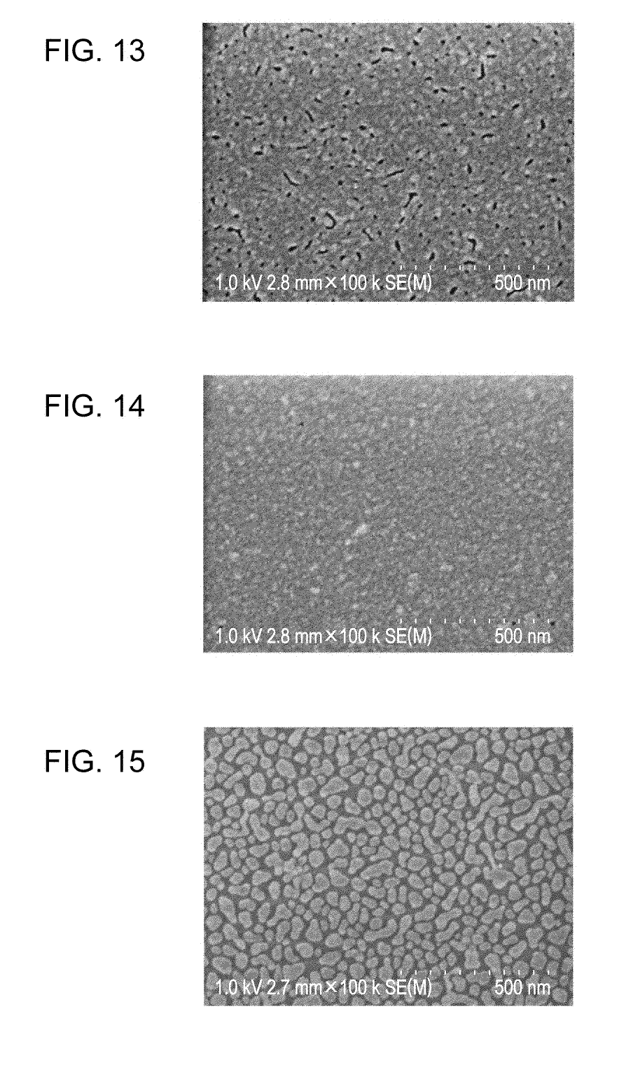

FIG. 13 is an SEM photograph showing appearance of the half mirror of Example 3. FIG. 14 is an SEM photograph showing appearance of the half mirror of Example 4. FIG. 15 is an SEM photograph showing appearance of the half mirror of Comparative Example 2. In the SEM photograph, relatively bright portions indicate that silver is present and relatively dark portions indicate that the foundation is exposed. The accelerating voltage of the SEM was 1 kV, and the magnification of the SEM was 100,000.

As indicated in FIG. 15, the half mirror of Comparative Example 2 not including the alloy layer has many aggregations of silver over an entire surface of the base. The diameter of the aggregation is about 50 to 100 nm. The aggregations were isolated from each other on the surface of the base and did not form a continuous film. When light enters the aggregations of silver, plasmon absorption causes the light loss.

Compared with this, as indicated in FIG. 13, it was confirmed that the half mirror of Example 3 having the silver-copper alloy layer having a thickness of 10.2 nm has less aggregation of silver due to the presence of copper, and a dense film to be a silver layer is formed. Furthermore, as indicated in FIG. 14, the half mirror of Example 4 having the silver-copper alloy layer having a thickness of 11.9 nm has appearance similar to that of the half mirror of Example 3. It was confirmed that the above-described alloy layer reduces the aggregation of silver.

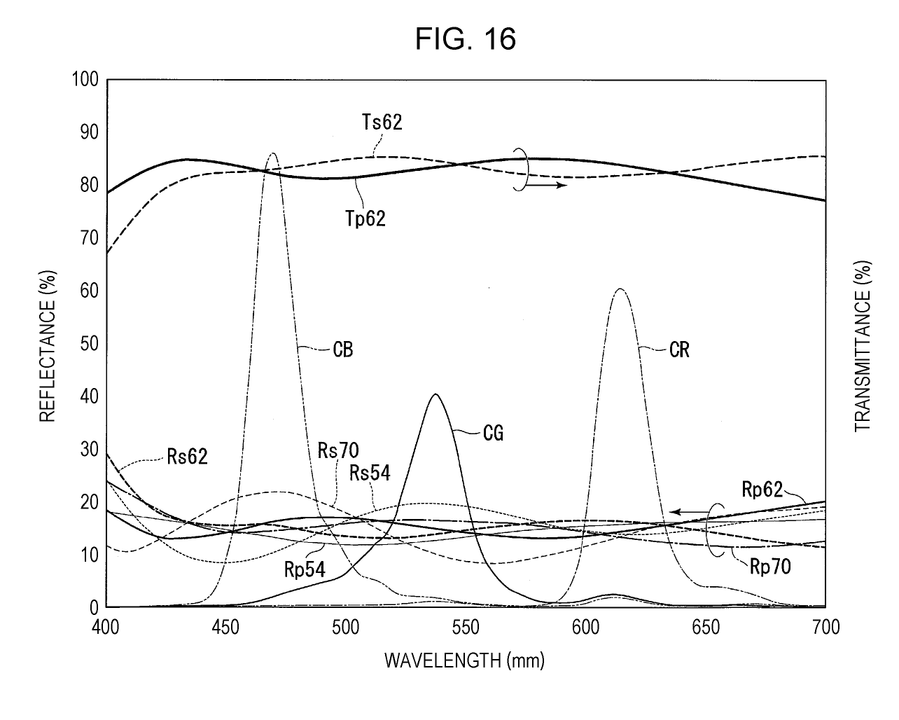

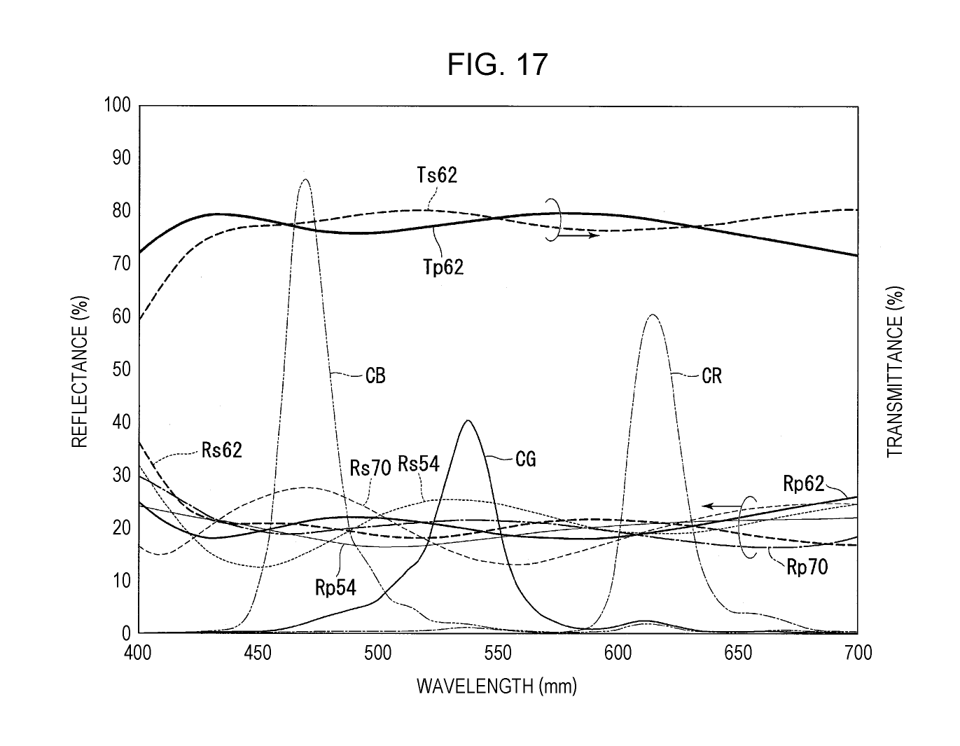

FIG. 16 is a diagram indicating spectral reflectance and spectral transmittance of the half mirror of Example 3. FIG. 17 is a diagram indicating spectral reflectance and spectral transmittance of the half mirror of Example 4.

In FIG. 16 and FIG. 17, the horizontal axis indicates wavelength (nm) and the vertical axis indicates reflectance (%) or transmittance (%). The curve with a reference symbol Rp 54 indicates spectral reflectance for the p-polarized component at an incident angle 54°. The curve with a reference symbol Rs 54 indicates spectral reflectance for the s-polarized component at an incident angle 54°. The curve with a reference symbol Rp 62 indicates spectral reflectance for the p-polarized component at an incident angle 62°. The curve with a reference symbol Rs 62 indicates spectral reflectance for the s-polarized component at an incident angle 62°. The curve with a reference symbol Rp 70 indicates spectral reflectance for the p-polarized component at an incident angle 70°. The curve with a reference symbol Rs 70 indicates spectral reflectance for the s-polarized component at an incident angle 70°. The curve with a reference symbol Tp 62 indicates spectral transmittance for the p-polarized component at an incident angle 62°. The curve with a reference symbol Ts 62 indicates spectral transmittance for the s-polarized component at an incident angle 62°.

In FIG. 16 and FIG. 17, the curve with a reference symbol CB indicates emission spectrum of blue light from the organic EL device as a light source. The curve with a reference symbol CG indicates emission spectrum of green light from the organic EL device as the light source. The curve with a reference symbol CR indicates emission spectrum of red light from the organic EL device as the light source.

As indicated in FIG. 16, in the half mirror of Example 3, the sum (not indicated) of the reflectance and the transmittance is close to 100% over the substantially entire visible wavelength range. It was confirmed that the amount of the absorbed light is small. As indicated in FIG. 17, in the half mirror of Example 4, the sum (not illustrated) of the reflectance and the transmittance is close to 100% over the substantially entire visible wavelength range as in the third example. It was confirmed that the amount of the absorbed light is small.

As indicated in FIG. 16 and FIG. 17, the wavelength dependence of the reflectance and the transmittance in the half mirrors of Examples 3 and 4 is smaller than that in the half mirrors of Examples 1 and 2 indicated in FIG. 9 and FIG. 10. This is probably resulted from the effect of the multiple dielectric layers of the half mirrors of Examples 3 and 4. In other words, the half mirror including the dielectric layers of various types on the upper and lower sides of the silver layer has reflectance and transmittance that varies little over a wide wavelength range. Furthermore, the spectral shape indicated in FIG. 16 and FIG. 17 is able to be adjusted by changing types or thickness of the laminated dielectrics to control the color balance and the color gamut of the output light.

### Third Embodiment: Display Device

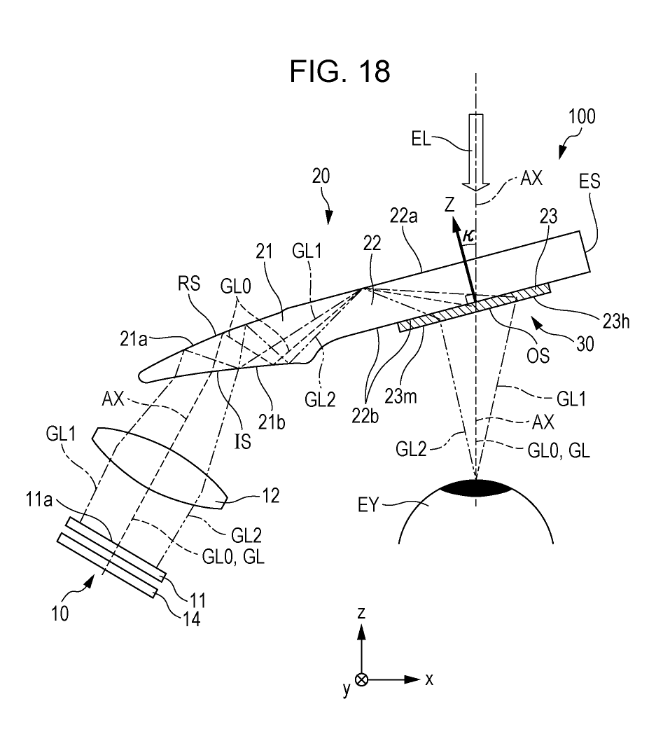

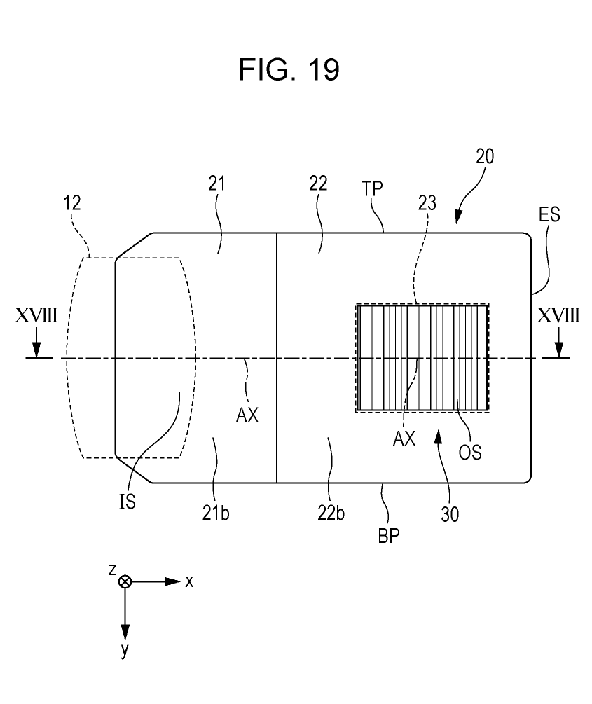

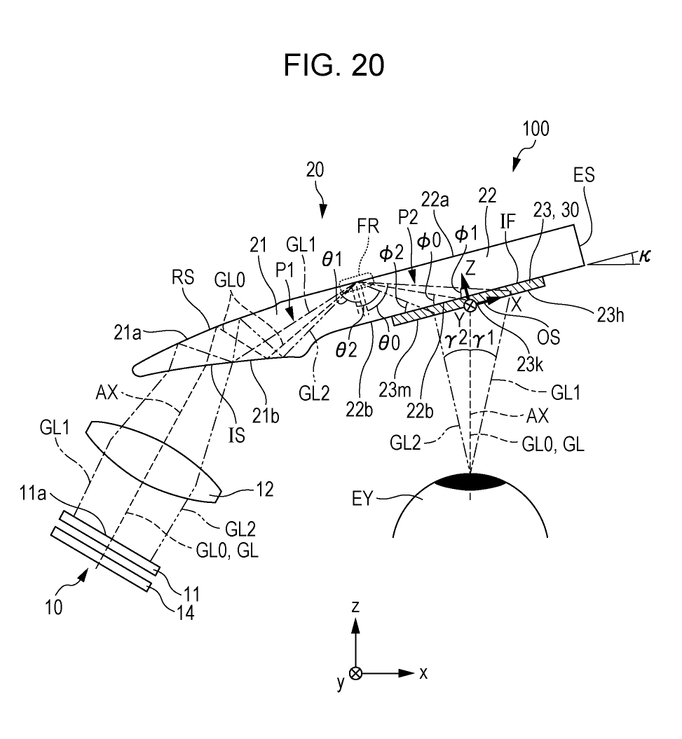

A display device of this embodiment is used as a head-mounted display configured to be worn on a user's head, for example. FIG. 18 is a cross-sectional view of a display device of this embodiment. FIG. 19 is a rear view of a light guide device seen from the side of the user. FIG. 20 is a view indicating optical paths of image light from the light guide device. In the following figures, for ease of understanding of the components, the components are illustrated at different scales in some cases.

### Overall Configuration of Light Guide Device and Display Device

As illustrated in FIG. 18, a display device 100 includes an image forming device 10 and a light guide device 20. The light guide device 20 in FIG. 18 corresponds to the light guide device 20 taken along line XVIII-XVIII in FIG. 19. The display device 100 allows a user to see a virtual image provided by the image forming device 10 and to see through it. In the display device 100, a pair of the image forming device 10 and the light guide device 20 is provided for each of the right eye and the left eye of the user. The devices for the right eye and the left eye have the same configuration except that the components are symmetrically arranged in the left-right direction. In FIG. 18, only the components for the left eye are illustrated and the components for the right eye are not illustrated. The display device 100 has an eyeglasses-like overall appearance, for example.

The image display device 10 includes an organic electroluminescence (EL) element 11 and a projection lens 12. The organic EL element 11 outputs image light GL that constitutes an image, such as a moving image and a still image. The image forming device may include a liquid crystal element, for example, not the organic EL element 11. The projection lens 12 is a collimator lens configured to make rays of the image light GL from different portions of the organic EL element 11 to be substantially parallel rays. The projection lens 12 is formed of glass or plastic and may include one or two or more lenses. The projection lens 12 is not limited to a spherical lens and may be a non-spherical lens, or a free-form surface lens, for example.

The light guide device 20 is composed of a planar light transmissive member. The light guide device 20 guides the image light GL generated by the image forming device 10 and outputs the image light GL toward the eye EY of the user while allowing the external light EL providing an outside image to pass therethrough. The light guide device 20 includes an input portion 21 configured to take in the image light, a parallel light guide 22 configured mainly to guide the image light, and an output portion 23 configured to allow the image light GL and the external light EL to exit. The parallel light guide 22 and the input portion 21 are integrally formed of a resin material having high light transmissivity. In this embodiment, the optical paths of the image light GL traveling through the light guide device 20 are the same type of optical paths that are reflected the same number of times, not a synthesized optical path including multiple types of optical paths. The light guide device 20 includes the parallel light guide 22 and the half mirror 53 configured to reflect some of the light that has traveled through the parallel light guide 22. The half mirror 53 is described later.

The parallel light guide 22 is tilted relative to the optical axis AX corresponding to the line of sight of the user's eye EY seeing the front side. The normal direction Z to a planar surface 22a of the parallel light guide 22 is tilted relative to the optical axis AX by an angle κ. With this configuration, the parallel light guide 22 is able to be positioned along the face and the line normal to the planar surface 22a of the parallel light guide 22 is able to be tilted relative to the optical axis AX. In this way, since the line normal to the planar surface 22a of the parallel light guide 22 is tilted by the angle κ relative to the z direction, which is parallel to the optical axis AX, image light GL0 on and near the optical axis AX that exits from the optical element 30 is tilted by the angle κ relative to the line normal to a light output surface OS. The direction parallel to the optical axis AX is the z direction. The horizontal and vertical directions perpendicular to the z direction are the x direction and the y direction, respectively.

The input portion 21 has a light input surface IS and a reflection surface RS. The image light GL from the image forming device 10 enters the input portion 21 through the light input surface IS. The image light GL in the input portion 21 is reflected by the reflection surface RS and guided in the parallel light guide 22. The light input surface IS includes a curved surface 21b recessed when seen from the side of the projection lens 12. The curved surface 21b also reflects all the image light GL reflected by the reflection surface RS at the inner side.

The reflection surface RS includes a curved surface 21a recessed when seen from the side of the projection lens 12. The reflection surface RS is composed of a metal film such as an aluminum film formed on the curved surface 21a by a vapor-deposition technique, for example. The reflection surface RS reflects the image light GL entered through the light input surface IS to bend the optical path. The curved surface 21b reflects all the image light GL reflected by the reflection surface RS to bend the optical path. In this way, the input portion 21 reflects the image light GL entered through the light input surface IS two times to bend the optical path to reliably guide the image light GL to the inside of the parallel light guide 22.

The parallel light guide 22 is a planar light guiding member extending parallel to the y axis and tilted relative to the z axis. The parallel light guide (a light guide) 22 is formed of a resin material having light transmissivity and has two planer surfaces 22a and 22b substantially parallel to each other. The planar surfaces 22a and 22b parallel to each other do not magnify the outside image and do not cause defocusing. The planar surface 22a functions as a total reflection surface that reflects all the image light from the input portion 21 and guides the image light GL to the output portion 23 with little loss. The planar surface 22a is a surface of the parallel light guide 22 positioned adjacent to the outside and functions as a first total reflection surface. The planar surface 22a may be referred to as an external surface in this specification.

The planar surface 22b may be referred to as a user side surface in this specification. The planar surface 22b (the user side surface) extends to one end of the output portion 23. Here, the planar surface 22b is an interface IF between the parallel light guide 22 and the output portion 23 (see FIG. 20).

In the parallel light guide 22, the image light GL reflected by the reflection surface RS or the light input surface IS of the input portion 21 enters the planar surface 22a, which is the total reflection surface, and fully reflected by the planar surface 22a toward the rear side of the light guide device 20, i.e., toward the +x side or the X side where the output portion 23 is disposed. As illustrated in FIG. 19, the parallel light guide 22 has an end surface ES as a +x side end surface of the light guide device 20. Furthermore, the parallel light guide 22 has an upper end surface TP and a lower end surface BP as ±y side end surfaces. The direction normal to the planar surface 22b is the Z direction. The horizontal and vertical directions perpendicular to the Z direction are the X direction and the Y direction, respectively.

As illustrated in FIG. 20, the output portion 23, which is located on the rear side of the parallel light guide 22 (on the +x side), has a planar shape and extends along the planar surface 22b or the interface IF. The output portion 23 reflects the image light GL, which has been fully reflected by an area FR of the planer surface (total reflection surface) 22a of the parallel light guide 22 adjacent to the outside, by a predetermined angle such that the image light GL is bent toward the light output surface OS. Here, the image light GL that enters the output portion 23 first and does not pass therethrough is a target to be extracted as a virtual image. In other words, the light reflected by the light output surface OS of the output portion 23 at the inner side is not used as the image light.

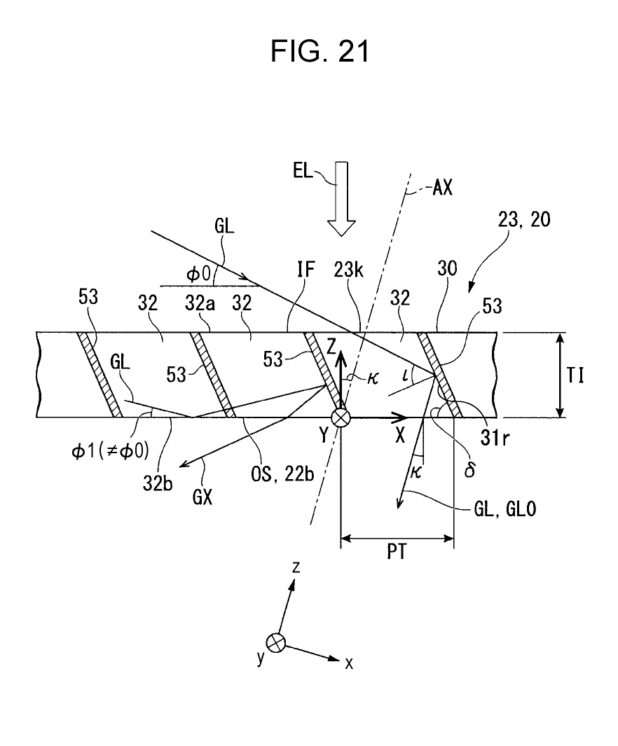

The output portion 23 includes an optical element 30 including a plurality of half mirrors 53 having light transmissivity. The half mirrors 53 are arranged in one direction. The structure of the optical element 30 is described later in detail with reference to FIG. 21, for example. The optical element 30 extends along the planar surface 22b of the parallel light guide 22 adjacent to the user.

In the light guide device 20 having the above-described configuration, as illustrated in FIG. 20, the image light GL that has been output from the image forming device 10 into the light guide device 20 through the light input surface IS is reflected many times in the input portion 21 such that the optical path of the image light GL is bent. Thus, the image light GL is fully reflected by the area FR of the planar surface 22a of the parallel light guide 22 to travel substantially along the optical axis AX. The image light GL reflected by a +z side portion of the area FR of the planar surface 22a enters the output portion 23.

The area FR has a width in the longitudinal direction of the xy-plane smaller than that of the output portion 23. In other words, a bundle of rays of the image light GL that enters the output portion 23 (or the optical element 30) has a larger incident width than a bundle of rays of the image light GL that enters the area FR. The smaller incident width of the bundle of rays of the image light GL that enters the area FR reduces the possibility that the optical path interference will occur. Thus, the image light GL from the area FR readily directly enters the output portion 23 (or the optical element 30) without being guided by the interface IF or without by being reflected by the interface IF.

The image light GL in the output portion 23 is bent at a proper angle in the output portion 23 to be extracted through the light output surface OS. The image light GL from the light output surface OS enters the eye EY of the user as a virtual image light. The virtual image light forms an image at the retina of the user such that the user recognizes the image light GL in the form of a virtual image.

Here, the incident angles of the image light GL, which is used to form an image, onto the output portion 23 gradually increase with distance from the input portion 21, which is located adjacent to the light source. In other words, the image light GL enters the rear portion of the output portion 23 at a large angle with respect to the Z direction perpendicular to the planar surface 22a adjacent to the outside or with respect to the optical axis AX and is bent at a relatively large angle, and the image light GL enters the front portion of the output portion 23 at a relatively small angle with respect to the Z direction or with respect to the optical axis AX and is bent at a relatively small angle.

### Optical Path of Image Light

Hereinafter, an optical path of image light is described in detail. As illustrated in FIG. 20, a component of the image light emitted from the organic EL element 11 through a middle section of the emission surface 11a is referred to as image light GL0, which is indicated by a dashed line, a component thereof emitted through a peripheral portion of the emission surface 11a on the left side in FIG. 20 (−x side and +z side), which is indicated by a one-dot chain line, is referred to as image light GL1, and a component thereof emitted through a peripheral portion of the emission surface 11a on the right side in FIG. 20 (+x side and −z side), which is indicated by a two-dot chain line, is referred to as image light GL2. The optical path of the image light GL0 extends along the optical axis AX.

The main components of the image light GL0, GL1, and GL2 passed through the projection lens 12 enters the light guide device 20 through the light input surface IS and travel through the input portion 21 and the parallel light guide 22 to the output portion 23. More specifically described, among the image light GL0, GL1, and GL2, the image light GL0 emitted from the middle section of the emission surface 11a is bent in the input portion 21 to gather in the parallel light guide 22, and then is fully reflected by the area FR of the planar surface 22a at a normal reflection angle θ0. Then, the image light GL0 passes through the interface IF between the parallel light guide 22 and the output portion 23 (or the optical element 30) without being reflected by the interface IF and directly enters a middle portion 23k of the output portion 23. The image light GL0 is reflected by the portion 23k at a predetermined angle to exit through the light output surface OS in the optical axis AX direction (a direction tilted by the angle κ with respect to the Z direction), which is tilted with respect to the XY-plane including the light output surface OS, in the form of parallel rays.

The image light GL1 emitted from one end (on the −x side) of the emission surface 11a is bent in the input portion 21 to gather in the parallel light guide 22, and then is fully reflected by the area FR of the planar surface 22a at a maximum reflection angle θ1. Furthermore, the image light GL1 passes through the interface IF between the parallel light guide 22 and the output portion 23 (or the optical element 30) without being reflected by the interface IF. The image light GL1 is reflected by a rear portion 23h (on the +x side) of the output portion 23 at a predetermined angle to exit through the light output surface OS in a predetermined direction in the form of parallel rays. In an output angle γ1 at this time, an angle at which the light returns toward the input portion 21 is relatively large.

The image light GL2 emitted from the other end (on the +x side) of the emission surface 11a is bent in the input portion 21 to gather in the parallel light guide 22, and then is fully reflected by the area FR of the planar surface 22a at a minimum reflection angle θ2. Furthermore, the image light GL2 passes through the interface IF without being reflected by the interface IF between the parallel light guide 22 and the output portion 23 (or the optical element 30). The image light GL 2 is reflected by a portion 23m on the front side (−x side) of the output portion 23 at a predetermined angle to exit through the light output surface OS in a predetermined direction in the form of a parallel rays. In an output angle γ2 at this time, an angle at which the light returns toward the input portion 21 is relatively small.

The three lines of the image light GL0, GL1, and GL2, which indicate components of the light, are representatives of components of the image light GL. The other components of the image light GL are guided in the same way as the image light GL0, GL1, or GL2, for example, and are output through the light input surface OS. Thus, the other components are not illustrated and described.

Here, if the refractive index n of the transparent resin material that forms the input portion 21 and the parallel light guide 22 is 1.4, for example, the critical angel θc is approximately 45.6°. The total reflection condition for necessary image light is satisfied by making the smallest reflection angle θ2 among the reflection angles θ0, θ1, and θ2 of the image light GL0, GL1, and GL2 larger than the critical angle θc.

The image light GL0 for the middle enters the portion 23k of the output portion 23 at an elevation angle φ0 (=90°−θ0). The image light GL1 for the periphery enters the portion 23h of the output portion 23 at an elevation angle φ1 (=90°−θ1). The image light GL2 for the periphery enters the portion 23m of the output portion 23 at an elevation angle φ2 (=90°−θ2). The elevation angles φ0, φ1, and φ2 reflect the magnitude relationship among the reflection angles θ0, θ1, and θ2 and satisfy the relationship of φ2>φ0>φ1. In other words, an incident angle ι (see FIG. 21) onto the half mirror 53 of the optical element 30 gradually decreases such that the incident angle onto the portion 23m corresponding to the elevation angle φ2 is the largest, the incident angle onto the portion 23k corresponding to the elevation angle φ0 is the second largest, and the portion 23h corresponding to the elevation angle φ1 is the smallest. In other words, the incident angle ι onto the half mirror 53 or the reflection angle at the half mirror 53 decreases with distance from the input portion 21.

The overall behavior of the bundle of rays of image light GL reflected by the planar surface 22a of the parallel light guide 22 adjacent to the outside toward the output portion 23 is described. As illustrated in FIG. 20, the bundle of rays of image light GL is narrowed down in the straight optical paths P1 or P2 before or after being reflected by the area FR of the parallel light guide 22 adjacent to the outside in a cross section having the optical axis AX. More specifically described, in the cross section having the optical axis AX, the bundle of rays of image light GL is narrowed down as a whole at the position around the area FR, i.e., in the area around the boundary between the straight optical paths P1 and P2 that extends over the straight optical paths P1 and P2, to have a smaller beam width. Thus, the bundle of rays of the image light GL is narrowed down before the output portion 23, readily making a viewing angle in a lateral direction relatively wide. In the example in FIG. 20, the bundle of rays of image light GL is narrowed down in the area extending over the straight optical paths P1 and P2 to have a smaller beam width but may be narrowed down at either of the straight optical paths P1 and P2 to have a smaller beam width.

### Configuration of Optical Element

Hereinafter, the configuration of the optical element 30 constituting the output portion 23 is described. FIG. 21 is a magnified view of the optical element 30 of the embodiment. The output portion 23 is composed of the optical element 30 on the surface of the parallel light guide 22 adjacent to the user. Thus, the output portion 23 extends along the XY-plane tilted with respect to the optical axis AX by the angle κ as the parallel light guide 22 does.

As illustrated in FIG. 21, the optical element 30 includes a plurality of half mirrors 53 and a plurality of transmissive members 32. The half mirrors 53 are parallel to each other with a distance therebetween. The half mirror 53 reflects some of the image light GL and some of the external light EL and transmits some of the image light GL and some of the external light EL. The transmissive members 32 are located between the adjacent half mirrors 53. In other words, in the optical element 30, the transmissive members 32 adjacent to each other sandwich the half mirror 53. In the optical element 30, the half mirrors 53 and the transmissive members 32 are alternately arranged.

The transmissive member 32 is a columnar member having a parallelogram cross-sectional shape when taken along line perpendicular to the longitudinal direction. The transmissive member 32 has first and second pairs of parallel planes extending in the longitudinal direction. One of the planes of the first pair is an input surface 32a through which the image light GL and the external light EL enter, and the other of the planes of the first pair is an output surface 32b through which the image light GL and the external light EL exit. The half mirror 53 is disposed on one of the planes of the second pair. The transmissive member 32 is formed of glass or transparent resin, for example.

The transmissive members 32 are configured such that the half mirrors 53 are arranged parallel to each other when units of one transmissive member 32 and one half mirror 53 are bonded together. Although not illustrated in FIG. 21, an adhesive layer is disposed between one surface of the half mirror 53 and the transmissive member 32 located next to the half mirror 53. Thus, the optical element 30 has a rectangular planar overall shape. When the optical element 30 is seen in a direction normal to the input surface 32a or the output surface 32b of the transmissive member 32, the thin belt-like half mirrors 53 are arranged in a stripe pattern. In other words, in the optical element 30, the rectangular half mirrors 53 are arranged in the longitudinal direction of the parallel light guide 22, i.e., in the X direction with a predetermined distance (pitch PT) therebetween.

The half mirror 53 is composed of a reflective film sandwiched between the transmissive members 32. The reflective film is composed of a dielectric multilayer film including alternately laminated dielectric thin films having different refractive indexes, for example. Alternatively, the reflective film may be composed of a metal film. The half mirror 53 has short sides tilted relative to the input surface 32a and the output surface 32b of the transmissive member 32. More specifically described, the half mirror 53 is tilted such that a reflective surface 31r faces the input portion 21 toward the outside of the parallel light guide 22. In other words, the half mirror 53 is tilted with respect to the YZ-plane perpendicular to the planar surfaces 22a and 22b such that the upper end (on the +Z side) of the longitudinal side (the Y direction) of the half mirror 53 is turned in a counterclockwise direction.

The reflectance of the half mirror 53 for the image light GL is 10% or more and 50% or less, for example, when the image light GL is incident at an angle in a possible incident angle range, in order to transmit the external light EL such that the user sees through it and readily sees the outside image. Furthermore, the reflectance of the half mirror 53 for the image light GL that has entered a surface of the half mirror 53 at a relatively small incident angle is smaller than the reflectance of the half mirror 53 for the image light GL that has entered the surface of the half mirror 53 at a relatively large angle. The effects and advantages obtained by this characteristic are described in detail later.

Hereinafter, the angle between the reflective surface 31r of the half mirror 53 and the output surface 32b is defined as an inclination angle δ of the half mirror 53. In this embodiment, the inclination angle δ of the half mirror 53 is 45° or more and smaller than 90°. In this embodiment, the refractive index of the transmissive member 32 and that of the parallel light guide 22 are equal to each other, but the refractive indexes may be different. If the transmissive member 32 and the parallel light guide 22 have different refractive indexes, the inclination angle δ of the half mirror 53 needs to be changed from that in the case having the equal refractive index.

The half mirrors 53 are tilted at the inclination angle δ of about 48° to about 70° in a clockwise direction with respect to the planar surface 22b of the parallel light guide 22 adjacent to the user, specifically at the inclination angle δ of 60°, for example. The elevation angle φ0 of the image light GL0 may be 30°, for example, the elevation angle φ1 of the image light GL1 may be 22°, for example, and the elevation angle φ2 of the image light GL2 may be 38°, for example. In such a case, as illustrated in FIG. 20, the image light GL1 and the image light GL2 enter the eye EY of the user at an angle γ1=γ2≈12.5° relative to the optical axis AX.

With this configuration, the image light GL is able to be efficiently extracted at an angle that allows the image light GL as a whole to gather onto the eye EY of the user, when a component of the image light GL reflected at a relatively large total reflection angle (the image light GL1) mainly enters the portion 23h of the output portion 23 on the +x side and a component of the image light GL reflected at a relatively small total reflection angle (the image light GL2) mainly enters the portion 23m of the output portion 23 on the −x side. In other words, the image light GL entering the input surface 32a of the optical element 30 from the light guide 22 at a relatively large incident angle (a relatively small elevation angle) is efficiently extracted from the parallel light guide 22. Since the optical element 30 is configured such that the image light GL is extracted at the above-described angle, the light guide device 20 allows the image light GL to travel through the optical element 30 basically only one time, not more than one time. Thus, the image light GL is extracted as virtual light with a small loss.

The pitch PT between the adjacent half mirrors 53 is about 0.5 mm to about 2.0 mm. The pitch PT between the half mirrors 53 may be not strictly equally spaced interval and may be a variable pitch. More specifically described, the pitch PT between the half mirrors 53 of the optical element 30 may be a random pitch in which the distance randomly increases or decreases from the reference distance. In this way, the arrangement of the half mirrors 53 in the random pitch in the optical element 30 reduces non-uniform diffraction and moiré pattern. The pitch is not limited to the random pitch. A predetermined pitch pattern in which the distance increases and decreases in a stepwise manner may be repeated.

The thickness of the optical element 30 or the thickness TI of the half mirror 53 in the Z-axis direction is about 0.7 mm to about 3.0 mm. The thickness of the parallel light guide 22 supporting the optical element 30 is about a few mm to about 10 mm, preferably about 4 mm to about 6 mm. The parallel light guide 22 having a thickness sufficiently larger than that of the optical element 30 reliably decreases the incident angle of the image light GL onto the optical element 30 or the interface IF and reduces the reflection of the image light GL at the half mirror 53 from which the image light GL does not travel to the eye EY. However, the parallel light guide 22 and the light guide device 20 are readily made lighter by making the parallel light guide 22 smaller.

Since the display device 100 of the embodiment includes the light guide device 20 including the half mirror 53 of the above-described embodiment, uneven brightness with vertical streaks is less likely to occur and thus a bright image is provided.

### Fourth Embodiment: Display Device

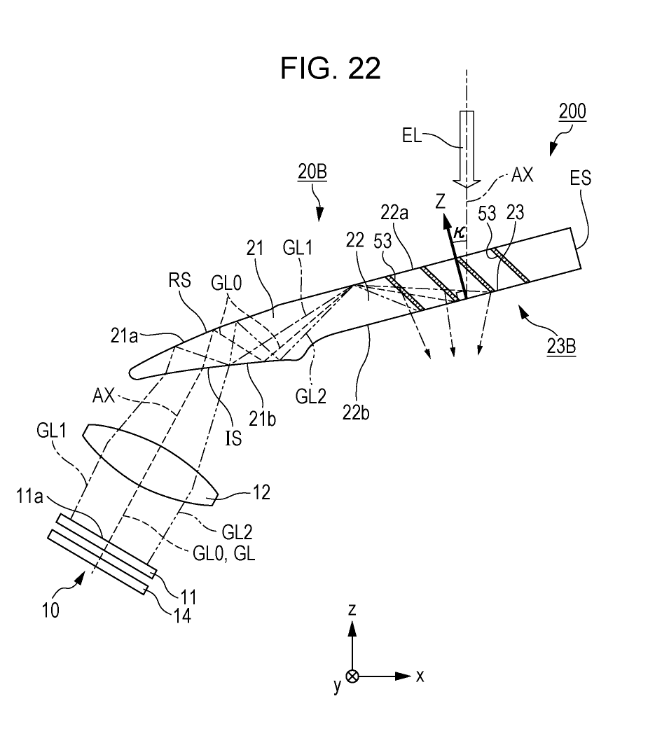

Hereinafter, a fourth embodiment of the invention is described with reference to FIG. 22. A display device according to the fourth embodiment has a basic configuration identical to that of the third embodiment except for the configuration of the light guide device. FIG. 22 is a cross-sectional view of a display device according to the fourth embodiment. In FIG. 22, components identical to those in the figures of the third embodiment are assigned the same reference numerals as those in the third embodiment and are not described.

As illustrated in FIG. 22, a display device 200 of this embodiment includes an image forming device 10 and a light guide device 20B. The image forming device 10 has the same configuration as that of the third embodiment. The light guide device 20B includes a light input portion 21 through which image light enters, a parallel light guide 22 that mainly guides the image light, and a light output portion 23B through which the image light GL and the external light EL exit.

The output portion 23 of the third embodiment is composed of the optical element 30 on the surface of the parallel light guide 22 adjacent to the user. The output portion 23B of this embodiment does not include the optical element 30, which is a separate component from the parallel light guide 22, and includes the half mirrors 53 in the parallel light guide 22. In this embodiment, the input portion 21 is produced by resin molding, and the parallel light guide 22 including the half mirrors 53 is produced by cutting out a laminated glass plate. The input portion 21 and the parallel light guide 22, which are separately produced, are connected together.

The display device 200 of this embodiment provides an image having less uneven brightness with vertical streaks, which is the same advantage obtained in the third embodiment.

The technical scope of the invention is not limited to the above-described embodiments. Various modifications may be added thereto without departing from the spirit of the invention. The number, shape, and material of components constituting the half mirror, the light guide device, and the display device are not limited to those in the above-described embodiments and may be suitably changed. For example, the image forming device may be an organic EL device or a combination of a laser light source and a MEMS scanner, other than a liquid crystal display device. The light guide device may be used in a lighting device, for example, other than in the display device.

The entire disclosure of Japanese Patent Application No. 2017-107694 filed May 31, 2017 is expressly incorporated by reference herein.

What is claimed is:

1. A half mirror comprising:
a silver layer; and
an anti-aggregation layer in contact with the silver layer.

2. The half mirror according to claim 1, wherein the anti-aggregation layer is composed of one of indium tin oxide and indium gallium oxide.

3. The half mirror according to claim 1, wherein the anti-aggregation layer is composed of an organic molecular film having a thiol group.

4. The half mirror according to claim 1, wherein the anti-aggregation layer is composed of an alloy including silver in an amount of 97% or more and an element X, the element X being any one of Au, Mg, Zn, Cu, Al, Si, Pd, Sn, Pt, Ti, and Cr.

5. The half mirror according to claim 1, wherein the silver layer has a thickness of 12 nm or less.

6. The half mirror according to claim 1, further comprising a dielectric layer in contact with the silver layer and a dielectric layer in contact with the anti-aggregation layer.

7. A half mirror comprising an alloy layer including silver in an amount of 97% or more and an element X, the element X being any one of Au, Mg, Zn, Cu, Al, Si, Pd, Sn, Pt, Ti, and Cr.

8. The half mirror according to claim 7, wherein the silver layer has a thickness of 12 nm or less.

9. The half mirror according to claim 7, further comprising a dielectric layer in contact with the alloy layer.

10. A light guide device comprising:
a light guide; and
the half mirror according to claim 1 that is configured to reflect some of light traveled in the light guide.

11. A light guide device comprising:
a light guide; and
the half mirror according to claim 2 that is configured to reflect some of light traveled in the light guide.

12. A light guide device comprising:
a light guide; and
the half mirror according to claim 3 that is configured to reflect some of light traveled in the light guide.

13. A light guide device comprising:
a light guide; and
the half mirror according to claim 4 that is configured to reflect some of light traveled in the light guide.

14. A light guide device comprising:
a light guide; and
the half mirror according to claim 5 that is configured to reflect some of light traveled in the light guide.

15. A light guide device comprising:
a light guide; and
the half mirror according to claim 6 that is configured to reflect some of light traveled in the light guide.

16. A light guide device comprising:
a light guide; and
the half mirror according to claim 7 that is configured to reflect some of light traveled in the light guide.

17. A light guide device comprising:
a light guide; and
the half mirror according to claim 8 that is configured to reflect some of light traveled in the light guide.

18. A light guide device comprising:
a light guide; and
the half mirror according to claim 9 that is configured to reflect some of light traveled in the light guide.

19. A display device comprising:
an image forming device; and
the light guide device according to claim 10 that is configured to guide image light generated by the image forming device.

20. A display device comprising:
an image forming device; and
the light guide device according to claim 11 that is configured to guide image light generated by the image forming device.
